(19) United States
(12) Patent Application Publication
(10) Pub. No.: US 2022/0332895 A1
(43) Pub. Date: Oct. 20, 2022

(54) POLYAMIDE-IMIDE POLYMER AND PROCESS FOR ITS MANUFACTURE

(71) Applicant: SOLVAY SPECIALTY POLYMERS USA, LLC, Alpharetta, GA (US)

(72) Inventors: Joel FLORES, Alpharetta, GA (US); Stéphane JEOL, Saint-Genis-Laval (FR)

(21) Appl. No.: 17/640,418

(22) PCT Filed: Sep. 8, 2020
(86) PCT No.: PCT/EP2020/074992

§ 371 Date: Mar. 4, 2022

Related U.S. Application Data
(60) Provisional application No. 62/897,473, filed on Sep. 9, 2019.

(51) Int. Cl. C08G 73/14; C08G 73/10

(52) U.S. Cl. CPC C08G 73/14; C08G 73/1007

(57) ABSTRACT

A process for preparing a polyamide-imide (PAI) polymer is provided. The process comprises the melt polymerization of a reaction mixture comprising at least one cycloaliphatic acid component comprising three carboxyl moieties, the carboxyl moieties selected from the group consisting of carboxylic acid, acid anhydride and ester functional groups, and at least one diamine component. The process comprises maintaining the reaction mixture in a liquid state and at a temperature of at least 200° C. during polymerization.

### CROSS REFERENCE TO RELATED APPLICATIONS

This application is a U.S. National Phase entry under 35 U.S.C. § 371 of International Application No. PCT/EP2020/07499274, filed Sep. 8, 2020, which claims priority to U.S. provisional application No. 62/897,473 filed on Sep. 9, 2019, the entirety of each of which being incorporated herein by reference.

### FIELD

A polyamide-imide (PAI) polymer, a polymer composition comprising the same, processes for making these and articles comprising them are provided.

### BACKGROUND

Polyamide-imides (PAI) are high performance polymers possessing outstanding thermal, chemical and mechanical properties and are, therefore, suitable for demanding applications where high mechanical strength, stiffness and low friction in combination with high temperature, corrosion, and wear resistance are required. For these reasons, they are widely used in the aerospace and automotive industries, and as insulations, coatings, solvent resistant membranes and in electronic devices.

PAI polymers contain both amide and imide functionalities in the backbone. Hence, PAI polymers tend to exhibit hybrid properties of polyamides and polyimides. The increased rigidity of the imide group imparts better hydrolytic, chemical and thermal stability to the polymers as well as superior mechanical properties especially to polymers based on aromatic monomers. Most commercial PAI polymers are indeed aromatic, typically based on trimellitic acid, trimellitic anhydride or trimellitic acid halide.

During the PAI preparation process, an imide is formed from the reaction between two neighboring carboxylic acid groups (or derivatives thereof, such as acid halides, acid anhydrides and esters) and primary amine-containing molecules. An amic acid is formed initially, which closes into an imide ring upon further removal of a molecule of water.

The imidization reaction generally requires high temperatures, especially for PAI polymers based on aromatic monomers. The use of high temperatures, however, leads to crosslinking side reactions, which result in PAI polymers with limited processability or even in thermoset-like structures. While said PAI polymers are chemically stable, their use is limited for certain applications due to their low flow during melt processing, their thermal intractability in conventional processing methods (i.e. their low capability of being melt processed) and their low solubility.

Several attempts have been made to improve these properties, while at the same time maintaining the good thermal and mechanical performances of said PAI polymers, notably by grafting the polymers, blending them with other types of polymers and/or forming composites with additives and inorganic fibers.

Other attempts to improve the solubility and the processability of said PAI polymers involve the incorporation of flexible linkages and alicyclic units into PAI polymeric chains. For example, JP 2017-186560 discloses a PAI based on cyclohexane-1,2,4-tricarboxylic acid-1,2-anhydride (CTA) (instead of trimellitic anhydride) and m-xylylenediamine (MXD). The process described in this document takes place in solution in organic solvent. The use of organic solvents exhibits major disadvantages. First, the recovery of the polymer after synthesis requires additional stages, such as the precipitation of the polymer from a nonsolvent and the washing and the drying of the polymer. Second, some solvents are toxic. Third, the polymer usually comprises residual amounts of solvent which can impact the mechanical performance of the polymer or its use for certain applications. In other cases, the solvent can cause color issues.

US 2011/160407 relates to a process for the preparation of PAI polymers by melt polymerization of at least one aromatic organic compound having carboxyl groups, of at least one diamine compound and optionally of at least one diacid compound. This document more precisely describes the use of trimellitic acid, pyromellitic acid, or anhydrides, esters or amides of these as the aromatic organic compound. However, the aromaticity of these reaction materials imparts color to the polymer (yellow to orange to red).

None of the above-listed documents describes an organic-solvent-free polymerization process to prepare a PAI polymer and the art would benefit greatly from the same.

### SUMMARY

In a first aspect, a process for preparing a polyamide-imide (PAI) polymer is provided. The process comprises the melt polymerization of a reaction mixture comprising:
a) at least one cycloaliphatic acid component comprising three carboxyl moieties, the carboxyl moieties selected from the group consisting of carboxylic acid, acid anhydride and ester functional groups; and
b) at least one diamine component.

The reaction mixture is maintained in a liquid state and at a temperature of at least 200° C. during polymerization.

In a second aspect, a polyamide-imide (PAI) polymer obtained by said process is provided.

In a third aspect, a polymer composition comprising said PAI polymer is provided.

In a forth aspect, an article comprising said PAI polymer or said polymer composition is provided.

### DETAILED DESCRIPTION

A process for preparing a polyamide-imide (PAI) polymer is provided. The process comprises melt polymerization of at least one cycloaliphatic acid component and at least one diamine component. The cycloaliphatic acid component comprises three carboxyl moieties selected from the group consisting of carboxylic acid, acid anhydride and ester functional groups. The process further comprises maintaining the reaction mixture in a liquid state during polymerization at a temperature of at least 200° C.

A colorless, transparent PAI polymer, with low branching and good mechanical properties is also provided. Such PAI polymer can therefore be processed using standard polymer processing technologies, such as extrusion and injection molding, into films and other articles.

The PAI polymer exhibits low and controlled branching, which contributes to the combination of optimized properties exhibited by the PAI polymer, e.g., enhanced solubility, melt-processability and moldability, combined with good thermal and mechanical properties, such as a high glass transition temperature (Tg). In particular, the PAI polymer can be easily processed using conventional polymer processing technologies such as extrusion and injection molding. Furthermore, the PAI polymer can be easily converted into films and other articles. Articles comprising the PAI polymer or polymer compositions comprising the PAI polymer are transparent and colorless, with a low yellowness index.

In the present description, unless otherwise indicated, the following terms are to be construed as follows.

The term “cycloaliphatic moiety” means an organic group which contains at least one aliphatic ring and does not contain aromatic rings. The cycloaliphatic moiety can be substituted with one or more straight or branched alkyl or alkoxy groups and/or halogen atoms and/or can comprise one or more heteroatoms, like nitrogen, oxygen and sulfur, in the ring.

The term “alkyl”, as well as derivative terms such as “alkoxy”, include within their scope straight chains, branched chains and cyclic moieties. Examples of alkyl groups are methyl, ethyl, 1-methylethyl, propyl, 1,1-dimethylethyl, and cyclopropyl. Unless specifically stated otherwise, each alkyl group may be unsubstituted or substituted with one or more substituents including, but not limited to, hydroxy, sulfo, C₁-C₆ alkoxy and C₁-C₆ alkylthio, provided that the substituents are sterically compatible and the rules of chemical bonding and strain energy are satisfied.

The term “halogen” or “halo” includes fluorine, chlorine, bromine and iodine, with fluorine being preferred.

Cycloaliphatic Acid Component

The PAI polymer is prepared from a reaction mixture comprising a cycloaliphatic acid component, a diamine component and optionally, a diacid component. In a preferred embodiment, the cycloaliphatic acid component is according to formulae (I) and/or (II):

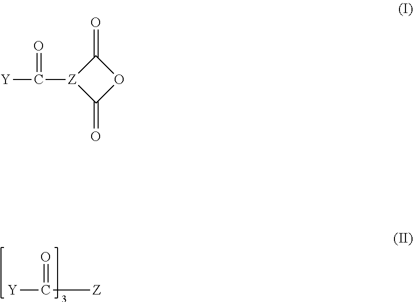

wherein:
Z is a cycloaliphatic moiety selected from the group consisting of substituted or unsubstituted, monocyclic or polycyclic groups having 5 to 50 carbon atoms, preferably 6 to 18 carbon atoms;
Y is ORₐ, with Rₐ being H or an alkyl, preferably an alkyl having 1 to 5 carbon atoms, and
in formula (II), at least two Y(C═O) are attached to 2 adjacent carbon atoms of Z, meaning that at least two carboxyl moieties are in ortho position with respect to one another.

Preferably, Z is a cycloaliphatic moiety comprising from one to four aliphatic rings. In case Z comprises more than one aliphatic ring, i.e. two aliphatic rings or more, said aliphatic rings may be condensed or may be bridged together either directly or by the following bridges: —O—, —CH₂—, —C(CH₃)₂—, —C(CF₃)₂—, or —(CF₂)_{q}—, wherein q is an integer from 1 to 5. The term “directly” means that the aliphatic rings are connected together through a bond.

Preferably, Z is a trivalent cycloaliphatic moiety selected from the group consisting of moieties of formulae (III-A), (III-B), (III-C) and (III-D):

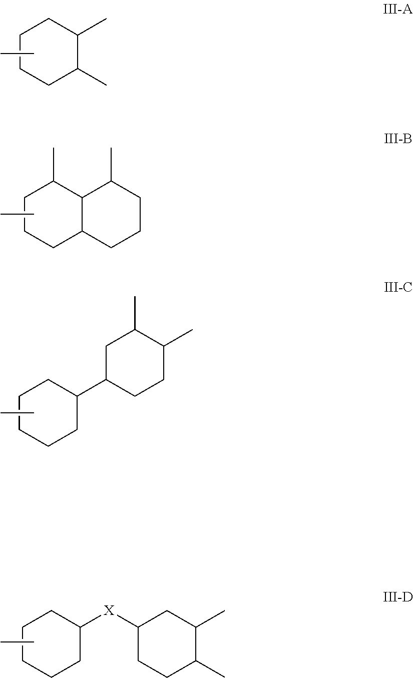

and corresponding substituted structures,
wherein X is —O—, —CH₂—, —C(CH₃)₂—, —C(CF₃)₂—, or —(CF₂)_{q}—, and q is an integer from 1 to 5.

In a preferred embodiment, the cycloaliphatic acid component is according to formulae (la) and/or (IIa):

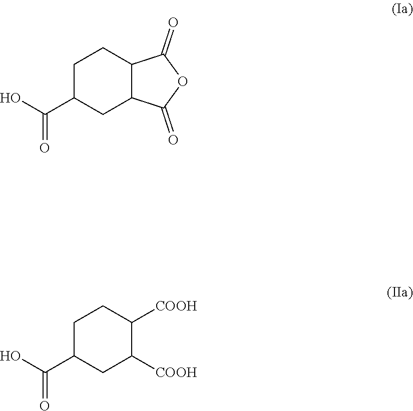 [SMILES: O=C(O)C1CCC2C(=O)OC(=O)C2C1 ; O=C(O)C1CCC(C(=O)O)C(C(=O)O)C1]

According to this embodiment, the process comprises:
the melt polymerization of the cycloaliphatic acid component according to formula (Ia) and at least one diamine component,
the melt polymerization of the cycloaliphatic acid component according to formula (IIa) and at least one diamine component, or
the melt polymerization of a mixture of the cycloaliphatic acid components according to formulae (Ia) and (IIa) and at least one diamine component.

Diamine Component

The reaction mixture subjected to melt polymerization further comprises at least one diamine component. The diamine component used in the process may be aliphatic, cycloaliphatic or aromatic. The diamine component comprises at least two amine moieties (—NH₂) and optionally at least one heteroatom, said heteroatom preferably selected from the group consisting of N, S and O.

The diamine component is preferably represented by the following formula:

H₂N—R—NH₂ (IV)

wherein R is a C4 to C50 divalent hydrocarbon radical, in particular a divalent aliphatic, cycloaliphatic or aromatic hydrocarbon radical.

The diamine component is preferably selected from the group consisting of putrescine, cadaverine, hexamethylenediamine, 2,2,4-trimethyhexamethylenediamine, 2,4,4-trimethyhexamethylenediamine, 1,9-diaminononane, 2-methyl-1,8-diaminooctane, dodecamethylenediamine, 1,3-bis(aminomethyl)cyclohexane, 1,4-bis(aminomethyl)cyclohexane, isophorone diamine, 1,4-diaminocyclohexane, 1,3-diaminocyclohexane, 4,4′-methylenebis(cyclohexylamine), 4,4′-methylenebis(2-methylcyclohexylamine), p-xylylenediamine, m-xylylenediamine and mixtures thereof.

The diamine component may consist of a mixture of distinct diamines, for example two or three distinct diamines.

Preferably, at least 50 mol. %, more preferably at least 65 mol %, even more preferably at least 80 mol. %, most preferably at least 95 mol. % of the diamine component is cycloaliphatic, based on the total number of moles of diamines in the diamine component.

According to an embodiment, the diamine component consists of a mixture of cycloaliphatic diamines, for example two or three distinct cycloaliphatic diamines.

According to another embodiment, the diamine component consists of only one cycloaliphatic diamine. In such embodiments, the diamine is preferably 1,3-bis(aminomethyl)cyclohexane.

Diacid Component

The reaction mixture subjected to melt polymerization optionally further comprises at least one diacid component or derivative thereof.

The expression “derivative thereof” indicates a derivative which is susceptible of reacting, under polycondensation conditions, to yield an amide bond. Examples of amide bond-forming diacid derivatives include acyl groups, for example aliphatic acyl and aromatic acyl groups, whether substituted or unsubstituted. Examples of acyl groups include, but are not limited to, formyl, acetyl, propionyl, butyryl, isobutyryl, valeryl, isovaleryl, pivaloyl, benzoyl, toluoyl and xyloyl.

The diacid component may be aliphatic, cycloaliphatic or aromatic and optionally comprises at least one heteroatomsselected from the group consisting of N, S and O.

The diacid component is preferably represented by the following formula:

HOOC—R′—COOH (V)

wherein R′ is a C4 to C18 divalent hydrocarbon radical, in particular a divalent aliphatic, cycloaliphatic or aromatic hydrocarbon radical.

The diacid component is preferably selected from the group consisting of adipic acid, azelaic acid, sebacic acid, dodecanedioic acid, isophthalic acid, terephthalic acid, 2,6-naphthalene dicarboxylic acid, 4,4′-bibenzoic acid, 5-hydroxyisophthalic acid, 5-sulfophthalic acid, 1,3-cyclohexanedicarboxylic acid, 1,4-cyclohexanedicarboxylic acid, and mixtures thereof.

Melt Polymerization

The PAI polymer is provided by a process comprising the melt polymerization of the above identified components. More precisely, said process comprises combining the cycloaliphatic acid component, the diamine component and the optional diacid component to provide a reaction mixture and maintaining the reaction mixture in a liquid state during polymerization at a temperature of at least 200° C.

The term “melt polymerization” means that the reaction mixture is maintained in a liquid state during polymerization at a temperature of at least 200° C.

Within the context of the present invention, the phrase “maintained in a liquid state” means that the reaction mixture remains in a liquid state without any solidification and/or precipitation of the resulting PAI polymer.

During polymerisation, the reaction mixture is constantly heated to increasing temperatures such that the PAI polymer under preparation is in a molten state. The minimum temperature to which the reaction mixture should be heated can generally be determined based on the melting or softening point of the PAI polymer being prepared. The melting or softening point of the PAI polymer being prepared may vary over polymerisation time based on the quantity of reactants involved in the reaction, notably the quantity of limiting reactant if for example one of the reactants is progressively added in the reaction mixture. In this case, the melting or softening point of the PAI polymer being prepared can be determined based on the complete conversion of the limiting reactant monomer. As the limiting reactant may be added sequentially in the reaction mixture, several temperature rises/increments may be necessary in order to prepare the PAI polymer of the present invention. Each step of the polymerization process is then conducted at a temperature not less than the melting or softening point of the PAI polymer being produced.

The process is conducted in the absence of an organic solvent. In other words, the process is organic-solvent-free, meaning that the reaction mixture does not comprise an organic solvent or comprises an amount of organic solvent which is less than 1 wt. %, less than 0.5 wt. % or even less than 0.2 wt %, based on the total weight of the reaction mixture. The process may include water as a solvent.

In some embodiments, the process is carried out in the absence of added water or in the presence of an amount of added water less than 50 wt. %, preferably less than 40 wt. %, more preferably less than 30 wt. %, even more preferably less than 15 wt. %, most preferably less than 5 wt. %, based on the total weight of the reaction mixture.

Accordingly, the reaction mixture can be an aqueous solution comprising the above identified components (i.e. the at least one cycloaliphatic acid component, the at least one diamine component and optionally the at least one diacid component. Preferably, the reaction mixture comprises water as solvent, since this facilitates the stirring of the reaction mixture and thus its homogeneity.

According to various embodiments, either the cycloaliphatic acid component or the diamine component is added sequentially, progressively or continuously to the reaction mixture.

Preferably, the reaction mixture contains said cycloaliphatic acid component (“CAC”) and said diamine component (“DC”) at a ratio (CAC:DC) ranging from 0.8 to 1.2 preferably from 0.9 to 1.1 more preferably from 0.95 to 1.05, even more preferably from 0.97 to 1.03.

When the process of the invention employs a diacid component, the diacid component and/or the diamine component can be introduced, at least in part, in the form of a salt of the diacid and/or diamine components.

The PAI polymer is generally obtained by polycondensation between the cycloaliphatic acid component(s), the diamine component(s) and optionally the diacid component(s) to form polyamide-imide chains with formation of the elimination product, in particular water. Preferably, the water generated during the process is evaporated, for example by fractional distillation using a condenser, at a pressure between 1 mbar and 30 bar.

The reaction mixture is maintained in a liquid state during polymerization at a temperature of at least 200° C., preferably from 215° C. to 300° C., in order to evaporate the water (present initially in the reaction mixture and/or formed during the polycondensation), while preventing any formation of solid phase in order to prevent the mixture from solidifying.

The process may be carried out under pressure, for at least a portion of the process. In these instances, a maximum pressure of 20 bar, preferably a maximum pressure of 10 bar, more preferably a maximum pressure of 3 bar, is used. The end of the process is preferably performed at low pressure (vacuum or atmospheric pressure), in order to drive the reaction towards completion and more easily remove the water generated during the process.

The process can be carried out in equipment made from materials inert to the above identified components (i.e. the cycloaliphatic acid component, the diamine component and the optional diacid component). In this case, the equipment is chosen in order to provide enough contact between said components and so that the removal of volatile reaction products, notably the water, is feasible. Suitable equipment includes agitated reactors, extruders and kneaders. The reaction vessel is preferably equipped with stirring means, for example a rotating shaft.

A chain-limiter or end-capping agent can be added to the reaction mixture to control the molecular weight of the resulting PAI polymer. A chain-limiter or end-capping agent is a molecule that has only one reactive site with amine and/or carboxylic acid. Examples of end-capping agents are monoamines, such as benzylamine and 1-hexaneamine, and monocarboxylic acids, such as acetic acid, propionic acid, benzoic acid, phthalic acid or anhydride.

Preferably, the order of introduction of the components into the reaction vessel during the process is as follows: water is added first, then the diamine component is charged and finally the cycloaliphatic acid component and, optionally, the diacid component are added.

Preferably, an inert gas, such as nitrogen gas, is introduced into the reaction vessel to replace the atmosphere in the vessel. Preferably, the reaction vessel is purged with said inert gas both before and after charging all the above identified components. Preferably, a flow of inert gas is maintained during the process.

Polyamide-Imide Polymer

A polyamide-imide (PAI) polymer obtained by the above defined process is also provided.

Preferably, said PAI polymer has a Tg of at least 100° C., more preferably of at least 120° C., even more preferably of at least 140° C., most preferably of at least 150° C., as determined by DSC according to ASTM D3418.

Preferably, said PAI polymer has a Tg of at most 250° C., more preferably of at most 240° C., even more preferably of at most 230° C., most preferably of at most 220° C., as determined by DSC according to ASTM D3418.

Preferably, said PAI polymer has a number average molecular weight (Mn) of at least 5,000 g/mol, more preferably of at least 10,000 g/mol, even more preferably of at least 15,000 g/mol, as determined by gel permeation chromatography (GPC) using a fluorinated solvent, 2 HFIP gel columns and UV-vis/refractive index detectors.

Preferably, said PAI polymer has an Mn of at most 50,000 g/mol, more preferably of at most 45,000 g/mol, even more preferably of at most 40,000 g/mol, as determined by gel permeation chromatography (GPC) using a fluorinated solvent, 2 HFIP gel columns and UV-vis/refractive index detectors.

Advantageously, said PAI polymer is soluble in a variety of solvents, notably in hexafluoro-2-propanol, o-cresol, sulfuric acid 98% and dimethylformamide.

The PAI polymer obtained by the process is in the molten form and as such, can be directly formed or can be processed using conventional polymer processing technologies such as extrusion and injection molding for subsequent forming after melting.

Furthermore, the PAI polymer according to the invention can be easily converted into films and other articles. Since the PAI polymer of the invention is soluble in a variety of organic solvents, films can advantageously be made from casting a solution containing the PAI polymer and then evaporating the solvent, following standard processes which are known to the person skilled in the art. In particular, said films can be made by dissolving the PAI polymer in a solvent to obtain a solution, casting the solution on a substrate and finally evaporating the solvent.

Said PAI polymer can be used in a large number of applications, in particular in the manufacture of yarns, fibers or filaments, or films, or in the forming of articles by injection molding, extrusion or extrusion/blow molding. It can in particular be used in engineered plastic compositions.

Polymer Composition

A polymer composition comprising the PAI polymer is also provided.

Preferably, the PAI polymer is present in the polymer composition in an amount of at least 10 wt. %, more preferably at least 15 wt. %, even more preferably at least 20 wt. %, most preferably at least 25 wt. %, based on the total weight of the polymer composition.

Preferably, the PAI polymer is present in the polymer composition in an amount of at most 99 wt. %, more preferably at most 95 wt. %, even more preferably at most 80 wt. %, most preferably at most 60 wt. %, based on the total weight of the polymer composition.

According to an embodiment, the PAI polymer is present in the polymer composition in an amount ranging from 10 to 70 wt. %, preferably from 20 to 60 wt. %, based on the total weight of the polymer composition.

According to an embodiment, said polymer composition comprises at least one additional additive selected from the group consisting of reinforcing agents, colorants, dyes, pigments, lubricants, plasticizers, flame retardants, nucleating agents, heat stabilizers, light stabilizers, antioxidants, processing aids, fusing agents, electromagnetic absorbers and combinations thereof.

Reinforcing agents, also referred to as reinforcing fillers or fibers, may be selected from the group consisting of fibrous reinforcing fillers, particulate reinforcing fillers and mixtures thereof. A fibrous reinforcing filler is considered herein to be a material having length, width and thickness, wherein the average length is significantly larger than both the width and the thickness. Generally, a fibrous reinforcing filler has an aspect ratio, defined as the average ratio between the length and the largest of the width and the thickness of at least 5, at least 10, at least 20 or at least 50.

Fibrous reinforcing fillers include glass fibers, carbon or graphite fibers, and fibers formed of silicon carbide, alumina, titania, boron and the like, and may include mixtures comprising two or more such fibers. According to an embodiment, said fibers are flat fibers. Non-fibrous reinforcing fillers include notably talc, mica, titanium dioxide, potassium titanate, silica, kaolin, chalk, alumina, mineral fillers, and the like.

A process of providing the polymer compositions is also provided and comprises mixing the PAI polymer with said at least one additional additive. Preferably, mixing the PAI polymer and said at least one additional additive is carried out by dry blending and/or melt compounding. More preferably, mixing the PAI polymer and said at least one additional additive is carried out by melt compounding, notably in continuous or batch devices. Such devices are well known to those skilled in the art. Examples of suitable continuous devices are screw extruders. Preferably, melt compounding is carried out in a twin-screw extruder.

Article

An article comprising said PAI polymer or said polymer composition is also provided.

The article is preferably a molded article. Preferably, said article is molded from the PAI polymer or the polymer composition comprising said PAI polymer using methods well known in the art, for example by methods including, but not limited to, injection molding, blow molding, rotomolding, compression molding or extrusion molding.

Should the disclosure of any patents, patent applications, and publications which are incorporated herein by reference conflict with the description of the present application to the extent that it may render a term unclear, the present description shall take precedence.

The invention will now be described with reference to the following examples, whose purpose is merely illustrative and not intended to limit the scope of the claims.

### Experimental Section

Materials

Cyclohexane-1,2,4-tricarboxylic acid-1,2-anhydride (CTA), available from Mitsubishi Gas Chemicals.

1,3-bis(aminomethyl)cyclohexane (1,3-BAC), available from Mitsubishi Gas Chemicals.

Hexamethylenediamine (NMDA), available from Ascend Performance Materials.

4,4′-methylenebis(cyclohexylamine) (PACM), available from Sigma-Aldrich.

Phosphorus acid, available from Sigma-Aldrich.

Methods

Thermal Analyses

The thermal properties were determined using differential scanning calorimetry (DSC). DSC analyses were carried out on DSC Q200-5293 TA Instrument according to ASTM D3418. Three scans were used for each DSC test: 1^{st} heating cycle to 300° C. at 20.00° C./min; 1^{st} cooling cycle to 30.00° C. at 20.00° C./min; 2^{nd} heating cycle to 300.00° C. at 20.00° C./min. The Tg was determined from the transition midpoint during the 2^{nd} heating cycle.

GPC

Mn was measured by gel permeation chromatography (GPC) using a fluorinated solvent, 2 HFIP gel columns and UV-vis/refractive index detectors.

Solubility

A 5-mg sample of the PAI polymer was added to 5 ml of solvent. The resulting mixture was stirred at room temperature for 24 to 48 hours and any dissolution or softening of the sample was noted. If the sample was completely dissolved, it was considered soluble. If the sample did not show any change in appearance after 48 hours, it was considered insoluble. Solubility in hexafluoro-2-propanol (HFIP), o-cresol, sulfuric acid 98% and dimethylformamide (DMF) was tested.

Yellowness Testing

Films having a thickness of 0.1-0.2 mm were prepared in a hot-press (280° C., 2000 lb-f). The yellowness index was measured on said films using an X-Rite Ci7800 spectrophotometer.

Mechanical Testing

PAI 1 polymer synthesized as described below was ground in a mill grinder and dried overnight at 120° C. under vacuum. The resulting material was injection molded into Type V tensile bars according to ASTM D3641, using a mold temperature of 140° C., a melt temperature of 290° C. and an injection pressure of 6 bars. Mechanical tests were performed on injection molded test specimens with a gauge length of 0.3 inch using the Instron 5569 machine and according to ASTM D638 at 23.2° C. with 54.7% humidity. The notched Izod impact strength was determined by ASTM D256 using injection molded test specimens.

Synthesis Methods

Polyamide-Imide 1 (PAI 1)

CTA (53.9 g), 1,3-BAC (39.1 g), phosphorus acid (0.032 g) and deionized water (42 g) were charged into a 300-ml reactor. Then, the reactor was purged with nitrogen for 5 minutes and stirred, and the polymerization reaction was carried out by heating to 280° C. within 2 hours. The steam generated was released upon reaching the target temperature. A vacuum was then applied to the reactor and the so obtained molten polymer was then held at this condition for another hour. Upon cooling, the polymer was taken out of the reactor and used for analyses.

Polyamide-Imide 2 (PAI 2)

CTA (55.6 g), 1,3-BAC (25.9 g), HMDA (11.7 g), phosphorus acid (0.032 g) and deionized water (42 g) were charged into a 300-ml reactor. Then, the reactor was purged with nitrogen for 5 minutes and stirred, and the polymerization reaction was carried out by heating to 280° C. within 2 hours. The steam generated was released upon reaching the target temperature. A vacuum was then applied to the reactor and the so obtained molten polymer was then held at this condition for another hour. Upon cooling, the polymer was taken out of the reactor and used for analyses.

Polyamide-Imide 3 (PAI 3)

CTA (50.7 g), PACM (27.1 g), HMDA (15.0 g), phosphorus acid (0.032 g) and deionized water (42 g) were charged into a 300-ml reactor. Then, the reactor was purged with nitrogen for 5 minutes and stirred, and the polymerization reaction was carried out by heating to 280° C. within 2 hours. The steam generated was released upon reaching the target temperature. A vacuum was then applied to the reactor and the so obtained molten polymer was then held at this condition for another hour. Upon cooling, the polymer was taken out of the reactor and used for analyses.

Results

Table 1 shows the Tg, the Mn, the yellowness index and the solubility results of PAI 1, PAI 2 and PAI 3 polymers prepared.

Table 2 shows mechanical properties of PAI 1.

TABLE 1

| | PAI 1 | PAI 2 | PAI 3 |
|---|---|---|---|
| CTA (mol) | 100 | 100 | 100 |
| 1,3-BAC (mol) | 100 | 65 | — |
| HMDA (mol) | — | 35 | 50 |
| PACM (mol) | — | — | 50 |
| Tg [° C.] | 176 | 150 | 160 |
| Mn [g/mol] | 21,290 | 34,240 | 19,160 |
| Yellowness index | 7.1 | 5.3 | 4.1 |
| Solubility in HFIP | soluble | soluble | soluble |
| Solubility in o-cresol | soluble | soluble | soluble |
| Solubility in sulphuric acid | soluble | soluble | soluble |
| Solubility in DMF | soluble | soluble | soluble |

TABLE 2

| | PAI 1 |
|---|---|
| CTA (mol) | 100 |
| 1,3-BAC (mol) | 100 |

Mechanical properties

| | |
|---|---|
| Modulus of elasticity (MPa) | 3,220 |
| Tensile stress at yield (MPa) | 113 |
| Tensile elongation at yield (%) | 4.9 |
| Tensile stress at break (MPa) | 108 |
| Tensile elongation at break (%) | 5.5 |
| IZOD Unnotched impact (ft-lb/in) | 10.5 |

As evidenced in Table 1 above, PAI polymers based on CTA and different diamines (1,3-BAC, HMDA and PACM) were successfully prepared. Said PAI polymers have number average molecular weights of greater than 19000 g/mol and show Tgs ranging between 150 and 176° C. The Tg could easily be adjusted by changing the nature and quantity of the diamine component.

Said PAI polymers also show a very low yellowness index.

Moreover, these PAI polymers revealed to be soluble in several organic solvents, which indicates that they have low and controlled branching.

As evidenced in Table 2, PAI 1 was melt processed and parts were made by injection molding, which indicates that PAI 1 also exhibits melt-processability and moldability. PAI 1 also shows excellent mechanical properties, with a combination of high tensile modulus and strength.

1-16. (canceled)

17. A process for preparing a polyamide-imide (PAI) polymer by melt polymerization of a reaction mixture comprising:
a) at least one cycloaliphatic acid component comprising three carboxyl moieties, the carboxyl moieties selected from the group consisting of carboxylic acid, acid anhydride and ester functional groups; and
b) at least one diamine component,
said process comprising maintaining the reaction mixture in a liquid state and at a temperature of at least 200° C. during polymerization.

18. The process of claim 17, wherein said at least one cycloaliphatic acid component is according to formulae (I) and/or (II): 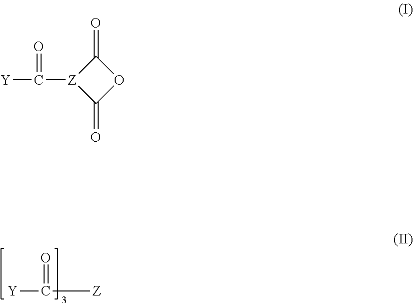
Z is a cycloaliphatic moiety selected from the group consisting of substituted or unsubstituted, monocyclic or polycyclic groups having 5 to 50 carbon atoms, preferably 6 to 18 carbon atoms;
Y is ORₐ, with Rₐ being H or an alkyl, preferably an alkyl having 1 to 5 carbon atoms; and
In formula II, at least two Y(C═O) moieties are in ortho position with respect to one another.

19. The process of claim 18, wherein Z is a cycloaliphatic moiety comprising from one to four aliphatic rings, said aliphatic rings being condensed or bridged together either directly or by the following bridges: —O—, —CH₂—, —C(CH₃)₂—, —C(CF₃)₂—, or —(CF₂)_{q}—, wherein q is an integer from 1 to 5.

20. The process of claim 18, wherein Z is a trivalent cycloaliphatic moiety selected from the group consisting of moieties having formulae (III-A), (III-B), (III-C) and (III-D): 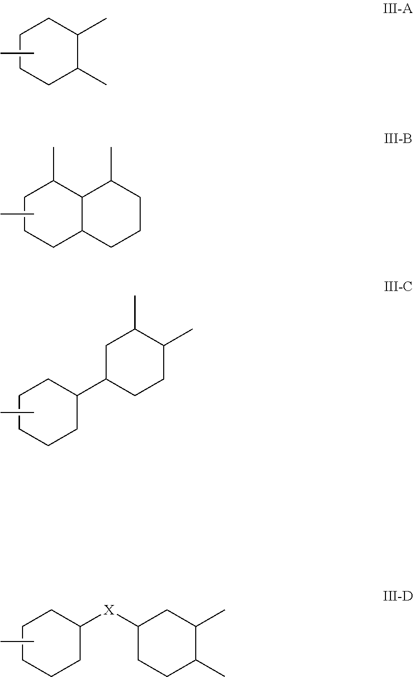
Wherein:
X is —O—, —CH₂—, —C(CH₃)₂—, —C(CF₃)₂—, or —(CF₂)_{q}—, and
q is an integer from 1 to 5.

21. The process of claim 17, wherein said at least one cycloaliphatic acid component is according to formulae (Ia) and/or (IIa):

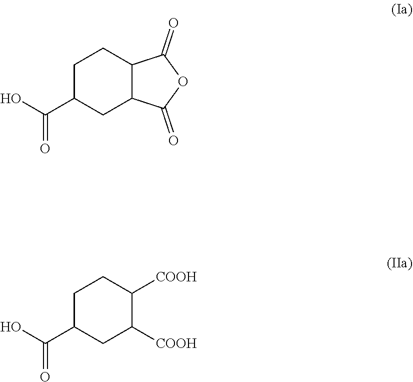 [SMILES: O=C(O)C1CCC2C(=O)OC(=O)C2C1 ; O=C(O)C1CCC(C(=O)O)C(C(=O)O)C1]

22. The process of claim 17, wherein the diamine component is aliphatic, cycloaliphatic or aromatic, and comprises at least two amine moieties and optionally at least one heteroatom selected from the group consisting of N, S and O.

23. The process of claim 22, wherein said diamine component is selected from the group consisting of putrescine, cadaverine, hexamethylenediamine, 2,2,4-trimethyhexamethylenediamine, 2,4,4-trimethyhexamethylenediamine, 1,9-diaminononane, 2-methyl-1,8-diaminooctane, dodecamethylenediamine, 1,3-bis(aminomethyl)cyclohexane, 1,4-bis(aminomethyl)cyclohexane, isophorone diamine, 1,4-diaminocyclohexane, 1,3-diaminocyclohexane, 4,4′-methylenebis(cyclohexylamine), 4,4′-methylenebis(2-methylcyclohexylamine), p-xylylenediamine, m-xylylenediamine, and mixtures thereof.

24. The process of claim 17, wherein the reaction mixture further comprises at least one aliphatic, cycloaliphatic or aromatic diacid component or derivative thereof, which optionally comprises at least one heteroatom selected from the group consisting of N, S and 0.

25. The process of claim 24, wherein said diacid component is selected from the group consisting of adipic acid, azelaic acid, sebacic acid, dodecanedioic acid, isophthalic acid, terephthalic acid, 2,6-naphthalene dicarboxylic acid, 4,4′-bibenzoic acid, 5-hydroxyisophthalic acid, 5-sulfophthalic acid, 1,3-cyclohexanedicarboxylic acid, 1,4-cyclohexanedicarboxylic acid, and mixtures thereof.

26. The process of claim 17, wherein the process is carried out in the absence of an organic solvent and in the presence of an amount of added water less than 50 wt. % based on the total weight of the reaction mixture.

27. The process of claim 17, wherein either the cycloaliphatic acid component or the diamine component is added sequentially, progressively or continuously to the reaction mixture.

28. The process of claim 17, wherein the water generated during the polymerisation is evaporated by fractional distillation at a pressure between 1 mbar and 30 bar.

29. A polyamide-imide (PAI) polymer obtained by melt polymerization of a reaction mixture comprising:
a) at least one cycloaliphatic acid component comprising three carboxyl moieties, the carboxyl moieties selected from the group consisting of carboxylic acid, acid anhydride and ester functional groups; and
b) at least one diamine component,
wherein the reaction mixture is maintained in a liquid state and at a temperature of at least 200° C. during polymerization.

30. The PAI polymer of claim 29, having a glass transition temperature of at least 100° C., and/or at most 250° C. as determined by DSC according to ASTM D3418.

31. The PAI polymer of claim 29, having a number average molecular weight (Mn) of at least 5,000 g/mol and/or at most 50,000 g/mol as determined by gel permeation chromatography using a fluorinated solvent, 2 HFIP gel columns and UV-vis/refractive index detectors.

32. The PAI polymer of claim 29, being soluble in hexafluoro-2-propanol, o-cresol, sulfuric acid 98%, and/or dimethylformamide.

33. A polymer composition comprising a polyamide-imide (PAI) polymer obtained by melt polymerization of a reaction mixture comprising:
a) at least one cycloaliphatic acid component comprising three carboxyl moieties, the carboxyl moieties selected from the group consisting of carboxylic acid, acid anhydride and ester functional groups; and
b) at least one diamine component,
wherein the reaction mixture is maintained in a liquid state and at a temperature of at least 200° C. during polymerization.

34. An article comprising the PAI polymer of claim 29.

35. An article comprising the polymer composition of claim 33.
